(19) United States
(12) Patent Application Publication
(10) Pub. No.: US 2022/0366265 A1
(43) Pub. Date: Nov. 17, 2022

(54) INTENT-INFORMED RECOMMENDATIONS USING MACHINE LEARNING

(71) Applicant: Adobe Inc., San Jose, CA (US)

(72) Inventors: Michele Saad, Austin, TX (US); Lauren Dest, Austin, TX (US)

(73) Assignee: Adobe Inc., San Jose, CA (US)

(21) Appl. No.: 17/319,776

(22) Filed: May 13, 2021

(51) Int. Cl. G06N 3/08; G06N 3/04

(52) U.S. Cl. CPC G06N 3/088; G06N 3/0454

(57) ABSTRACT

Techniques are provided for generating intent-informed recommendations by encoding, into a first machine learning network, one or more features representing one or more interactions between at least one member of a first group of users and at least one resource, and extracting, from the first machine learning network, one or more features representing one or more interactions between at least one member of a second group of users and the at least one resource. Using the extracted features, an intent value can be determined by clustering the features of the first and second groups of users into at least one cluster using a second machine learning network. In turn, the intent value informs or otherwise feeds a recommendation engine that is configured to generate at least one recommendation of at least one resource based at least in part on further user interaction data associated with a user session.

### FIELD OF THE DISCLOSURE

This disclosure relates generally to the field of machine learning, and more particularly, to techniques for using machine learning to generate intent-informed product recommendations by leveraging business-to-business (“B2B”) shopper trends to infer shopper intent in business-to-customer (“B2C”) stores.

### BACKGROUND

Predicting the intent of a user to purchase a specific product can be useful for generating product recommendations that may satisfy that intent and thus induce sales. For example, the behavior of a shopper, representing when that shopper will take an action and what will trigger that shopper to take that action, can be predicted by analyzing various factors such as prior actions of the shopper or the prior actions of similarly situated shoppers. Such prior actions can include, for example, browsing items for sale in on an e-commerce platform and either subsequently purchasing one or more of those items (or a different item) or leaving the online session without making any purchase. Existing behavioral models for intent prediction attempt to measure both subjective beliefs and normative behaviors to determine how likely a shopper is to make a purchasing decision. However, there are many different factors that influence behavior, each to varying degrees among different people, making the task of predicting intent both difficult and complex. For example, shoppers involved in commercial transactions are driven by behaviors rooted in business-related decisions more so than shoppers involved in non-commercial (e.g., personal or leisure) transactions, and thus these two types of shoppers may exhibit very different observable behaviors even when sharing the similar intent to purchase certain products or services. Furthermore, existing techniques for predicting intent are largely based on surveys, which are somewhat unreliable, as well as observable behavior, which provides very limited and indirect information about underlying intent. To the extent that behavioral data can be collected, machine learning can be used to model and translate behavior into a prediction of intent.

Machine learning has been used in analytical processing systems to perform complex analyses on electronic transactions and interactions between people and goods, services, sources of information, and other resources that are for sale. These analyses provide valuable insight about how these interactions occur and predictions about future interactions that can be used to generate recommendations for users in real-time as they interact with, for example, an e-commerce environment. For example, prior behavioral data collected online from businesses, consumers, and other entities can be used to develop machine learning models of preferences and interests with respect to future interactions by users with certain resources. Further machine learning models have been developed to enable rapid retrieval, interpretation, and interaction with these preferences and interests. In turn, using these models, the behavioral data can be applied in ways that produce relevant and meaningful drivers of future behavior, such as online product or service recommendations, pricing, production and inventory, or other types of analytically driven online activities.

The functionality, and thus the usefulness, of the model is a function of, among other things, the underlying data used to train the model. As noted above, there are many different factors that influence behavior, and therefore a model that is trained on data that only represents behaviors of one type or class of user, such as a consumer, likely will not reflect larger and meaningful analytical trends that are driven by other types or classes of users, such as commercial or business users. For example, so-called first-party data is data collected by the user of the data, and thus the granularity of this type of data is controllable by the user. By contrast, so-called third-party data is data collected by another data provider and tends to be more generalized and thus less valuable than first-party data. Alone, first-party data or third-party data has limited usefulness for machine learning because either it only represents a relatively small subset of user behavior (in the former case) or an overly generalized representation of user behavior (in the latter case). Combining first-party data with third-party data in machine learning is difficult because these data are not easily normalized for training a useful model. Thus, the ability of users to retrieve, interpret, and interact with the results is limited by the functionality of the model, which is defined by the underlying data. Therefore, complex and non-trivial issues associated with finding a way to train and implement machine learning models in analytical processing techniques remain, particularly with respect to predicting the intent of one type of user to purchase a specific product (or other resource) based on the behavior of another type of user so that the intent can be used to generate product recommendations that are likely to satisfy that intent and thus induce sales of those products or resources.

### SUMMARY

Techniques are provided herein for using machine learning to generate intent-informed product recommendations based on behaviors of groups of users having diverse online personas. Although useful in a number of applications, the techniques provided herein are particularly useful for generating personalized recommendations of products, services, sources of information, and other resources that are relevant to the intent of a given user within an e-commerce environment. In this context, intent is a unique facet of behavior that describes an aspect of user motivation that is different from preferences and interests. For instance, while preferences and interests are useful for identifying a set of products that are potentially relevant to the user, intent describes how the user is likely to react to the product recommendations at a given moment in time. For example, a user may have an intent to purchase a product imminently during an online session (such as on an e-commerce website), or an intent to browse or window shop for products without necessarily committing to a purchase during the current online shopping session. Regardless of the buyer's intent, note that the preferences and interests of that prospective buyer remain the same. To this end, a buyer's intent is distinct from that buyer's preferences and interests. As such, the type of intent for a given user can be used to drive different types of recommendations, such as exploitation recommendations or exploration recommendations. For example, when the user's intent is indicative of an imminent purchase, then exploitation recommendations can be generated for products that are related but not redundant, such as a coffee maker and one or more accessories for the coffee maker (e.g., reusable filter), when the user is likely to imminently purchase (at least) the coffee maker. In another example, when the user's intent is indicative of casual browsing, then exploration recommendations can be generated for multiple alternative products, such as different models or brands of coffee makers. Furthermore, intent can change independently of preferences and interests depending on certain time-dependent factors. For example, a user may have a generalized interest in a certain style of bathing suits, but the user's intent to purchase those suits may depend on the time of year when the recommendation is generated due to the seasonal nature of the product's use. During warmer months, or just prior to summer, the user may have a more imminent intent to purchase a bathing suit than during colder months or just after summer has ended, when the user is less likely to commit to a purchase of a bathing suit.

In more detail, and according to an embodiment of the present disclosure, a method is provided for generating intent-informed recommendations by encoding, into a first machine learning network, one or more features representing one or more interactions between at least one member of a first group of users and at least one resource. The encoding includes propagating a first set of behavioral data through a plurality of layers in the first machine learning network. The encoded first machine learning network can include an auto-encoder neural network that is configured to produce outputs that match or are similar to the inputs, thus providing the ability to extract one or more features from any given set of inputs. Once the network is encoded (trained), the method includes extracting, from the first machine learning network, one or more features representing one or more interactions between at least one member of a second group of users and the at least one resource. The extracting includes applying a second set of behavioral data to the first machine learning network. Using the extracted features, as well as the features used to encode the network, an intent value can be determined by clustering the features of the first and second groups of users into at least one cluster using a second machine learning network. The intent value represents, for example, a number of times the relevant feature is encoded into a node of the first machine learning network or another relevant measure of the strength of the intent (such as imminent (strong) versus distant (weak) intent). In another example, the intent value can represent a likelihood that a given user will behave in a certain manner, such as to purchase a given resource during a current user session or to merely browse or otherwise search for a variety of resources without necessarily committing to a purchase of any resource. In turn, the intent value informs or otherwise feeds a recommendation engine that is configured to generate at least one recommendation of at least one resource (e.g., a good, service, information, or other product) based at least in part on further raw user interaction data associated with a user session (e.g., a user currently interacting with a webpage). The recommendation, which is relevant to the intent as well as the current user interaction, can then be presented to the user in relation to the resource, such as by displaying one or more recommended products on a product webpage.

Any number of non-transitory machine-readable mediums (e.g., embedded memory, on-chip memory, read only memory, random access memory, solid state drives, and any other physical storage mediums) are used to encode instructions that, when executed by one or more processors, cause an embodiment of the techniques provided herein to be carried out, thereby allowing for training and using a machine learning network to generate intent-informed recommendations. Likewise, the techniques can be implemented in hardware (e.g., logic circuits such as a field programmable gate array, purpose-built semiconductor, or a microcontroller with a number of input/output ports and one or more embedded routines). Numerous variations and embodiments of the disclosed techniques will be appreciated in light of this disclosure.

### BRIEF DESCRIPTION OF THE DRAWINGS

FIG. 1 illustrates an example intent-informed recommendation system for training and using machine learning to generate intent-informed recommendations, in accordance with an embodiment of the present disclosure.

FIG. 2 is a block diagram representing an example use case scenario for the recommendation system of FIG. 1, in accordance with an embodiment of the present disclosure.

FIG. 3 is a block diagram representing a methodology for generating intent-informed recommendations using the recommendation system of FIG. 1, in accordance with an embodiment of the present disclosure.

FIG. 4 shows the structure of an example auto-encoder network that is a component of the intent-informed recommendation application of FIG. 1, in accordance with some embodiments of the present disclosure.

FIG. 5 is a block diagram of the second machine learning network that is a component of the intent-informed recommendation application of FIG. 1, in accordance with some embodiments of the present disclosure.

FIG. 6 is a block diagram of an example methodology for generating intent-informed recommendations, in accordance with an embodiment of the present disclosure.

FIG. 7 is a block diagram of another example methodology for generating intent-informed recommendations, in accordance with an embodiment of the present disclosure.

### DETAILED DESCRIPTION

Product recommendation systems are often used in online sales platforms, particularly in the business-to-customer context. Such systems are configured to identify products (physical objects or services being offered for sale) that a prospective buyer is likely to purchase, and to recommend those products to that buyer with an expectation that the recommendation will encourage the buyer to convert that product viewing session into a purchase. The recommendations are based on collected behavioral data associated with the prospective buyer and possibly other similarly situated prospective buyers. The behavioral data may represent, for instance, the types of products a given prospective buyer clicks on or otherwise views online, and supplemental products prospective buyers tend to purchase when making a main product purchase. In some systems, recommendations are made based on functional similarity, such as the case where a seller presents to a prospective buyer one or more recommendations of other products that are similar to the product that buyer is currently viewing, by, for example, taking into account product features. There remain, however, non-trivial problems with existing product recommendation systems.

For instance, existing product recommendation algorithms are prone to relatively poor accuracy, given the volatile nature of shopper behavior in the B2C space. This limitation on prediction accuracy stems from technological shortcomings of current online product selling platforms. In particular, current online selling platforms fail to discern or leverage the difference between different shopper personas when generating product recommendations. For instance, a business-to-business (B2B) shopper persona differs from the B2C shopper persona, because in the B2B space, the prospective buyer or shopper is often carrying out routine and regular purchases as a part of their professional capacity at a given company. In this regard, B2B shoppers are often adhering to a list of pre-approved vendors and products and repeating this purchase flow at a consistent cadence. On the other hand, B2C shoppers typically don't make repeat purchases and are much less predictable. Such shortcomings preclude the determination and delivery of more accurate product recommendations to an online buyer. To this end, complex and non-trivial technical issues associated with online selling platforms remain.

This disclosure provides techniques for generating intent-informed product recommendations from diverse groups of user behaviors. More specifically, techniques are disclosed for training and using one or more machine learning networks that can be used to predict user intent based on behavioral data relating to multiple groups of users, each exhibiting different behavior patterns. Two example such groups include, for instance, B2B online shoppers and B2C online shoppers. The predicted, or inferred, intent obtained from the machine learning network(s) can then be used to inform or otherwise feed a product recommendation engine to provide intent-informed product recommendations, which are different from recommendations based on preferences, interests, or other behavior of a specific user or single class of similarly behaving users. The recommendation engine is part of an analytics system that suggests products, services, sources of information, and other resources to users based on a variety of factors, such as current and prior behavior of an individual user or other users who share similar characteristics with a given user or group of users. The recommendation engine enable users to efficiently access products, services, and sources of information that are relevant and meaningful through suggestions that are tailored to each user. For example, behavioral data of B2B shoppers interacting with a B2B website is first collected by monitoring B2B shopper interactions, which may include, for instance, online shopping and browsing history indicative of user's interactions with an online selling platform (or other data indicative of accessing and/or using certain resources) over a period of time. This B2B behavioral data is then fed into a machine learning network (e.g., a neural network) that is configured to identify patterns within the interactions. The patterns, in turn, inform filters (e.g., a content-based filter or a collaborative filter) of the recommendation engine that select certain resources to be suggested to a B2C shopper interacting with a B2C website. The result is that B2C users can, via the intent-informed recommendations, more easily and quickly locate resources that meet their preferences and interests.

Existing techniques that only use shopper behavioral data to generate product recommendations, without considering shopper intent, tend to create a recommendation bias that fails to account for certain motivating factors. For example, a first group of users may include commercial or business users who frequently interact with certain resources (e.g., B2B online shoppers), such as when making purchasing decisions in an online environment. By contrast, a second group of users may include ordinary consumers who have fewer interactions with the same or similar resources and thus make fewer purchasing decisions (e.g., B2C online shoppers). While the intent of the users in the first group is fairly predictable—for instance, commercial users tend to make regular and repeated transactions with certain goods or services—the intent of the users in the second group is less predictable. For example, most B2C consumers tend to spend more time searching, browsing, or otherwise seeking resources (e.g., goods, services, information, etc.) before making a purchasing decision, relative to B2B commercial users, who are more familiar with the resources through frequent interactions with those resources (e.g., commercial users are more likely to make repeated purchases of the same goods, services, information, etc., than retail consumers). Therefore, the intent of the first group of users tends to be one of an imminent purchase or transaction, while the intent of the second group of users could be either imminent or distant, depending on what resources the user is seeking, among other factors that can be inferred from the user's behavior pattern.

Current online selling platforms, including those that utilize machine learning techniques, fail to appreciate and exploit or otherwise leverage this distinction because of the complexity of normalizing behavioral data from different types of users. In addition, current online selling platforms lack the intelligence to discern between different types of shopper intent. For instance, the intent of a shopper that intends to buy a specific product is quite different from the intent of a shopper that is browsing and possibly more open to a broader range of product recommendations. However, current online selling platforms treat such diversely intentioned buyers the same way and are not able to leverage the behaviors of different types of shoppers when using intent to generate product recommendations.

As will be appreciated in light of this disclosure, the accuracy with which user intent can be predicted and used to inform recommendations increases significantly when behavioral data from a group of users representing less volatile and more reliable sources (e.g., such as B2B shoppers) is analyzed with behavioral data from the more volatile group including individual users and similar users (e.g., such as B2C shoppers). This application of different groups of behavioral data involves training a machine learning network using the behavioral data of a first group of users, applying the behavioral data from a second group of users to the trained model, and then clustering the data from both groups to more accurately infer intent of the second group (e.g., B2C shoppers), which strengthens correlations between recommendations across diverse user personas.

In more detail, existing online product recommendation systems rely on techniques that do not model behavioral data from a leverage group of users (e.g., B2B shoppers) representing less volatile and more reliable sources in conjunction with behavioral data from a target group (e.g., B2C shoppers) including individual users and similar users; nor do such systems discern between types of shopper intent (e.g., imminent purchase versus casual browsing). At best, existing product recommendation techniques are limited to determining product recommendations based on a B2C shopper's prior interactions with an online selling platform or the interactions of other B2C shoppers who have had similar interactions with that platform, without considering that B2C shopper's specific intent. In contrast to existing recommendation systems, an embodiment of the present disclosure can be used to recommend products (or other resources, as the case may be) to a B2C shopper according to that B2C shopper's intent by leveraging machine learning networks that are uniquely trained for predicting and correlating the intent of one group of users (e.g., B2B shoppers), who have predictable behavioral patterns, with the intent of another group of users (e.g., B2C shoppers), who have relatively unpredictable behavioral pattern. Because the behaviors of one group of users can be different from the behaviors of another group of users, it difficult to model intent from these different behaviors without taking additional steps in training and applying the machine learning networks to correlate these behaviors.

For instance, if a shopper is searching for a coffee maker, the disclosed techniques can be used to determine whether the shopper's intent is to imminently purchase a particular model of coffee maker or to continue researching a range of products over a longer period of time before making a purchasing decision. This is achieved, in some examples, by training a first machine learning model on the behavioral data of a less volatile group of shoppers (that is, users with more predictable purchasing intent, such as B2B shoppers), seeding a second machine learning model with the intent derived from the first machine learning model, and then clustering the behavioral data of both groups of shoppers (e.g., B2B and B2C) based on the intent inferred from both of the models. The clusters represent the specific type of intent associated with a given shopper but is the product of predictive models representing several diverse sets of behavioral data, and this intent determination can be used to more accurately drive the type of product recommendations provided to the shopper during an online browsing session. This process of training and applying the machine learning networks allows the recommendations to be tailored more closely to the intent of the shopper than is possible using existing intent prediction techniques that do no leverage diverse sets of behavioral data in this way. For example, and continuing with the coffee maker example, a shopper with an imminent intent to purchase a particular brand of coffee maker may be provided with recommendations for related resources that complement that particular coffee maker, while a shopper with a distant intent to purchase may be provided with recommendations for alternative coffee makers that may have a greater appeal to the user rather than limiting the recommendations around one particular coffee maker. Note that the coffee maker in this example can be any other product or resource. Thus, with the disclosed techniques, recommendations can not only be based on behavior of a diverse group of shoppers (e.g., B2B and B2C shoppers) so as to improve the accuracy of the recommendations, but can further be personalized to reflect the specific intent of the B2C shopper in addition to, or instead of, the B2C shopper's preferences and interests.

### Term Definitions

As used herein, a “machine learning network” refers to a data model that is configured to analyze and extract inferences from patterns in a set of input data, through training and adaptation. in response to new inputs without human intervention or explicit programming. A machine learning network can include a supervised or semi-supervised learning network, an unsupervised learning network, or any combination of these. One example of a machine learning network is an auto-encoder neural network; however, other examples will be apparent (such as methodologies for converting a fixed number of inputs into a fixed number of outputs, or clustering methodologies).

As used herein, a “feature” refers to an individual measurable property, pattern, or characteristic within a set of input data. A set of features is referred to as a feature vector. For example, a machine learning network can be configured to classify the input data into one or more features.

As used herein, “behavioral data” or “user interaction data” or “raw user interaction data” refers to a set of data representing a sequence of events describing interactions between a user and at least one resource. For example, the behavioral data of and online shopper, or a group of online shoppers, can represent a series of product searches, product webpage views, product purchases, or any other online activity or interaction conducted by the shopper(s) on a given online selling platform over a period of time. The shopper may be, for instance, a B2B shopper or a B2C shopper.

As used herein, “intent” refers to an aspect of user motivation that can be ascribed to a certain behavior or series of acts performed by a given shopper or other user. Intent is different from user preferences and interests. For instance, while preferences and interests are useful for identifying a set of products or other resources that are potentially relevant to the user, intent describes how the user is likely to react to a situation or scenario at a given moment in time. Depending on the timing, for instance, a given online shopper may have imminent intent to buy or more casual intent to buy, but the preferences and interests of that shopper can remain the same, regardless of which intent type that shopper is experiencing.

Overview

As noted above, machine learning models used in conjunction with current recommendation systems do not discern the specific intent of the user in part because of the difficulty of normalizing and correlating diverse sets of behavioral data. Specifically, current product recommendation techniques leverage data representing only the prior behavior of a given B2C shopper or similar B2C shoppers to provide personalized suggestions of products, services, sources of information, or other resources. This prior behavior can include, for example, browsing, interaction, and purchase histories with respect to certain goods, services, sources of information, or other resources. These histories reflect a given B2C shopper's preferences and interests because browsing, interaction, and purchasing are specific to the user's needs, and thus is relatively easy to predict a shopper's preferences and interests when considering similar behavioral data. However, these existing techniques do not accurately predict B2C shopper intent, which is different from preferences and interests. For instance, a B2C shopper with an intention to browse or window shop is different from an intention to purchase a specific item or access a specific service. As will be appreciated, intent can be even more varied than these two categories, and thus is not limited to a binary choice. To this end, a shopper's intent can be modeled from not only the prior behavioral data of that shopper but also using the prior behavioral data of a different type of shopper and clustered or grouped into any one of two or more groups, which provides a more accurate prediction of intent that is not possible using existing machine learning models.

In accordance with an embodiment of the present disclosure, intent can be inferred by training a machine learning model (e.g., a supervised model, an unsupervised model, a semi-supervised model, a regression model, a classification model, or any combination of these) to extract dominant intent patterns in one or more sets of behavioral data. Unlike with prior techniques, the behavioral data is diverse in that it extends beyond the prior behavior of a given user or other similar users; rather, it includes the prior behavior of different groups of users who may have different motivations for accessing specific types of resources. For example, a first group of users can include a B2B user and a second group of users can include a B2C user. As noted above, a B2B user may have a different motivation, or intent, for accessing a particular resource than a B2C user, and such intent can be predicted using a combination of behavioral data sets from diverse groups of users. For example, a B2B user typically adheres to a list of pre-approved vendors and products and repeats the same interaction behavior at a consistent cadence, therefore making the intent of these shoppers more reliably predictable than a B2C user that has fewer and less scripted (if not irregular or one-off) interactions with the same resources. Thus, the prior behavior of the B2B user is different from the prior behavior of the B2C user. Once the machine learning network is trained, behavioral data representing a different type or group of users is applied to the machine learning model to extract features that are representative of the B2C user's intent. Intent is represented by a value, and features associated with B2B and B2C users are clustered with one another according to this value. Users in the same cluster are considered to have similar intent, and thus this intent can be used to generate specific intent-informed recommendations for these users, as discussed herein. Note that while providing recommendation to B2C user is one aspect of the present disclosure, further note that comparable recommendations can be made to B2B users or other types of users. Numerous variations and embodiments of the disclosed techniques will be appreciated in light of this disclosure.

Example Intent-Informed Recommendation System

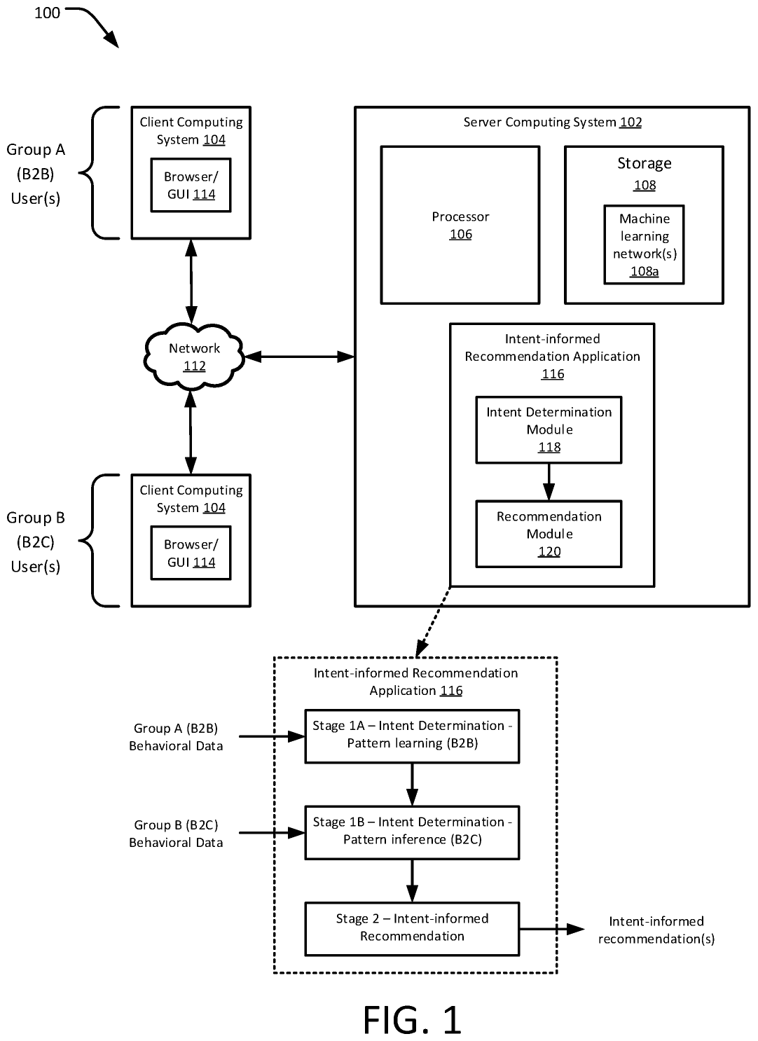

FIG. 1 illustrates an example intent-informed recommendation system 100 for training and using at least one machine learning network to generate intent-informed recommendations, in accordance with an embodiment of the present disclosure. The system 100 includes a server computing system 102 having at least one processor 106, one or more storage devices 108, including a non-transitory storage medium, and an intent-informed recommendation application 116. The system 100 further includes one or more client computing devices 104 each having a browser/graphical user interface (GUI) 114. The browser/GUI 114 is configured to interact with the server computing system 102 (via a network 112).

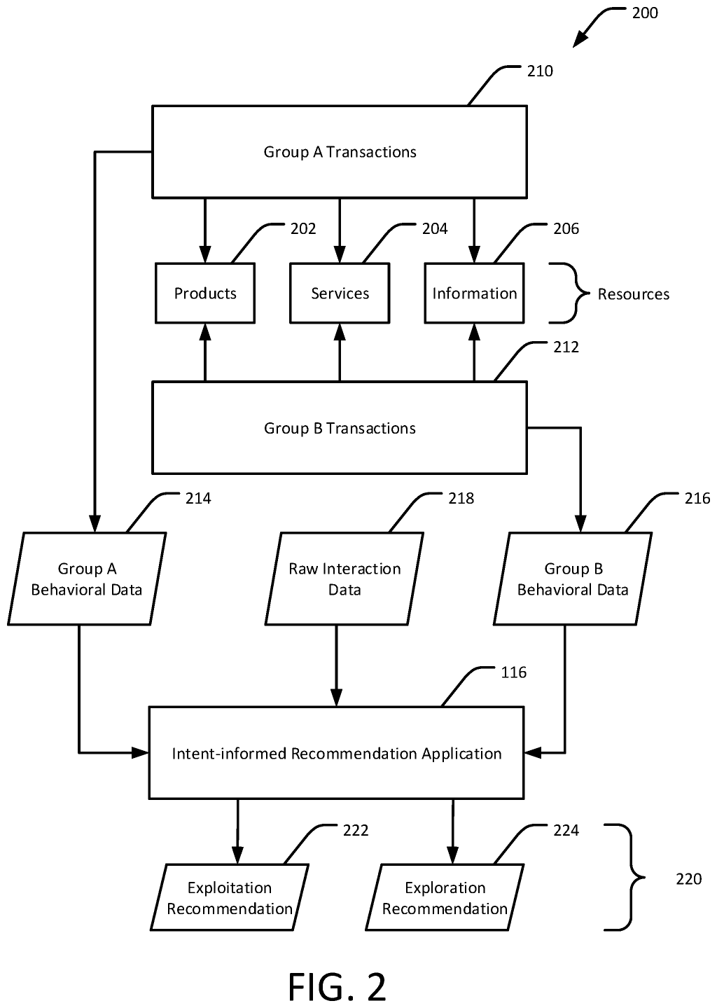

The processor 106 of the server computing system 102 is configured to execute the intent-informed recommendation application 116, which includes the following modules, each of which is described in further detail below: an intent determination module 118 and a recommendation module 120. Each of the modules 118 and 120 execute in conjunction with each other to perform a process for using machine learning to generate intent-informed recommendations. For example, the intent-informed recommendation application 116 can be configured to execute in several stages, including an intent determination stage (Stage 1) and an intent-informed recommendation stage (Stage 2). Stage 1 can be divided into at least two sub-stages, Stage 1A and Stage 1B. In Stage 1A, the application 116 is configured to learn patterns in a first group of behavioral data (e.g., Group A, or B2B) by encoding the data into one or more machine learning networks 108a. In Stage 1B, the application 116 is configured to infer patterns of intent from a second group of behavioral data (e.g., Group B, or B2C) by extracting one or more features of the data using the encoded (trained) machine learning network(s) 108a. In Stage 2, the application 116 is configured to generate one or more recommendations for a given user, such as a B2C user, using the inferred intent extracted from the machine learning network(s) 108a, such as described in further detail with respect to FIGS. 2-7. The recommendations can be provided to a user of the client computing system 104 via the browser/GUI 114.

In some embodiments, the server computing system 102 is configured to receive or retrieve user behavioral data that are stored in an external storage and/or the storage device(s) of the system 100. In some embodiments, the external storage is local to the server computing system 102 (such as an external hard drive) or remote to the server computing system 102 (such as cloud-or network-based storage). The external storage includes, for example, a stand-alone external hard drive, an external FLASH drive or memory, a networked hard drive, a server, and/or networked attached storage (NAS).

The client computing system 104 can include a computer system, such as a workstation, desktop computer, server, laptop, handheld computer, tablet computer (e.g., the iPad® tablet computer), mobile computing or communication device (e.g., the iPhone® mobile communication device, the Android™ mobile communication device, and the like), or other form of computing or telecommunications device that is capable of communication and that has sufficient processor power and memory capacity to perform at least some of the operations described in this disclosure. In some embodiments, a distributed computational system is provided including a plurality of server computing systems 102 and client computing systems 104. Further note that the client computing system 104 includes, for example, a client in a client-server environment, where at least a portion of the intent-informed recommendation application 116 on the server computing system 102 is served or otherwise made accessible to the client computing system 104 via the network 112 (e.g., the Internet and a local area network that is communicatively coupled to the client computing system 104).

The system 100 includes one or more storage devices or non-transitory computer-readable mediums having encoded thereon one or more computer-executable instructions or software for implementing techniques as variously described in this disclosure. The storage device(s) includes a computer system memory or random access memory, such as a durable disk storage (which includes any suitable optical or magnetic durable storage device, e.g., RAM, ROM, Flash, USB drive, or other semiconductor-based storage medium), a hard drive, CD-ROM, or other computer readable mediums, for storing data and computer-readable instructions or software that implement various embodiments as taught in this disclosure. In some embodiments, the storage device(s) includes other types of memory as well, or combinations thereof. The non-transitory computer-readable medium includes, but is not limited to, one or more types of hardware memory, non-transitory tangible media (for example, one or more magnetic storage disks, one or more optical disks, one or more USB flash drives), and the like. The non-transitory computer-readable medium stores computer-readable and computer-executable instructions or software for implementing various embodiments (such as instructions for an operating system as well as image processing software that includes the intent-informed recommendation application 116).

Example Use Case

FIG. 2 is a block diagram representing an example recommendation engine use case scenario 200, in accordance with an embodiment of the present disclosure. In the scenario 200, transactions or interactions by at least two groups of users or entities with one or more products 202, services 204, sources of information 206, or other resources is captured in one or more data sets. For example, Group A transactions 210 represent transactions or interactions by a first group of users with the products 202, services 204, sources of information 206, or other resources, and Group B transactions 212 represent transactions or interactions by a second group of users with the products 202, services 204, sources of information 206, or other resources. In some examples, the first group of users (e.g., Group A) includes B2B users and the second group of users (e.g., Group B) includes B2C users. However, the composition of the first and second groups of users can vary, as will be appreciated. Furthermore, it will be understood that more than two groups of user transactions can be utilized in accordance with the disclosed techniques.

In any case, the Group A transactions 210 are different from the Group B transactions 212, and at least some members of Group B are different from the members of Group A. These differences between the Group A transactions 210 and the Group B transactions 212 provide a degree of diversity in the respective data that is used to infer user intent with respect to the transactions and interactions with the various resources. The Group A transactions 210 can include, for example, browsing, purchasing, or any other interactions the members within the first group of users performed with respect to the products 202, services 204, sources of information 206, or other resources. Group B transactions can include, for example, browsing, purchasing, or any other interactions the members within the second group of users perform with respect to the products 202, services 204, sources of information 206, or other resources.

Group A behavioral data 214 is a first set of data representing transactions 210 by one or more members of the first group of users over a first period of time, and Group B behavioral data 216 is a second set of data representing transactions 212 by one or more members of the second group of users over a second period of time. The first and second periods of time can be the same or different and can further overlap or be mutually exclusive. In some examples, data within the Group A behavioral data 214 and/or the Group B behavioral data 216 can be weighted according to age, such that older data is given less weight than newer data. Other ways of weighting the data can be used, as will be appreciated, such as weighting by time period, frequency of transaction activity, or based on the types of transactions with various resources. In any event, both the Group A behavioral data 214 and the Group B behavioral data 216 represent transactions by both Group A and Group B with respect to the same or similar products 202, services 204, sources of information 206, or other resources, which makes the Group A behavioral data 214 and the Group B behavioral data 216 comparable.

The intent-informed recommendation application 116 uses the Group A behavioral data 214, the Group B behavioral data 216, and any additional raw user interaction data 218 representing transactions and interactions not included in the Group A transactions 210 and the Group B transactions 212. As will be described in further detail below, the intent-informed recommendation application 116 is configured to determine, based on the Group A behavioral data 214, the Group B behavioral data 216, and the raw user interaction data 218, an intent of a given user or group of users, and to generate one or more recommendations 220 for the user or group of users, including an exploitation recommendation 222 and/or an exploration recommendation 224, based at least in part on the intent of the user. Exploitation refers to recommendations of products or resources that are compatible with or otherwise similar to a user's prior transactions and interactions. For example, if the user has an imminent intent to purchase a certain coffee maker model, then the exploitation recommendations can include products that are compatible with or otherwise useful with the selected coffee maker (such as coffee filters, coffee beans, coffee maker accessories, etc.) Exploration refers to recommendations of resources that are not compatible with or otherwise similar to a user's prior transactions and interactions. For example, if the user has a distant intent to purchase a coffee maker (i.e., the user is unlikely to purchase the selected coffee maker during the current user session), then the exploration recommendations can include different models of coffee makers and/or other types of beverage-related products. Accordingly, exploitation recommendations are useful when a given user's intent is to complete, immediately or within a relatively short amount of time, a transaction or interaction with a specific product or resource, so as to encourage, guide, and speed up such activity. By contrast, exploration recommendations are useful when a user's intent is to browse a range of products or resources by providing a broader set of recommendations to the user with the expectation that by doing so, the user will be more likely to find and purchase a product or resource that suits their needs.

Example Methodology for Generating Intent-Informed Recommendations

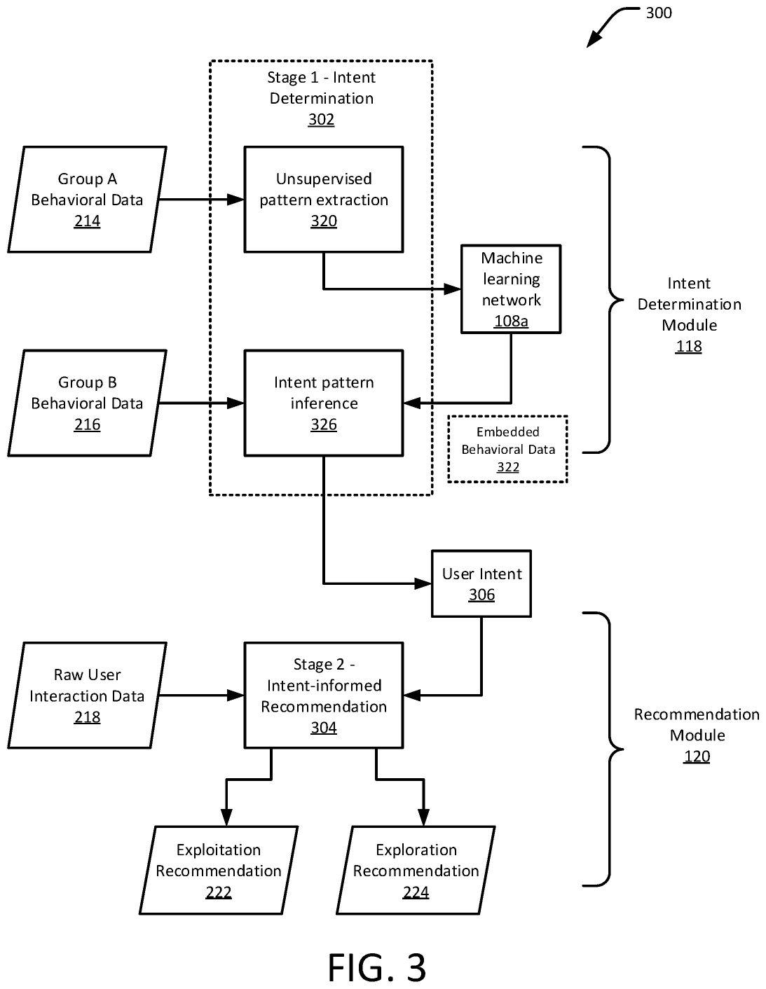

FIG. 3 is a block diagram representing a methodology 300 for generating intent-informed recommendations, in accordance with an embodiment of the present disclosure. The methodology 300 can be implemented, for example, in the system 100 of FIG. 1. The methodology 300 includes two processing stages: Stage 1—Intent Determination (302) and Stage 2—Intent-informed Recommendation (304). The Group A behavioral data 214 and the Group B behavioral data 216 are inputs to the Intent Determination stage 302. The Intent Determination 302 stage includes an unsupervised pattern extraction process 320 that learns and identifies repeatable trends or other patterns of behavior in the Group A behavioral data 214 and encodes, or embeds, the patterns in a machine learning network. For example, the Group A behavioral data 214 can include a set of interactions or transactions, such as searching, browsing, and/or purchasing one or more resources (e.g., goods, services, sources of information, or other resources) by one or more users who are members of the first group of users. As noted above, in some examples the first group of users represents B2B users, such as users who frequently engage in commercial transactions with a specific resource or set of resources. However, it will be understood that the first group of users can include any type and number of users.

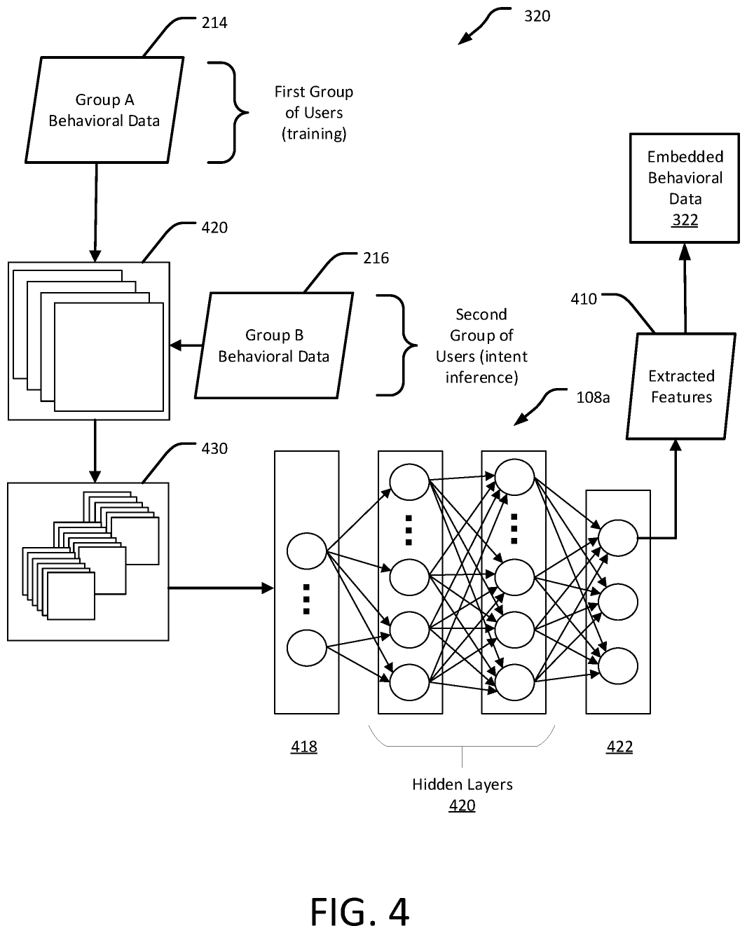

In some examples, the unsupervised pattern extraction process 320 is implemented as an auto-encoder network, such as shown in FIG. 4. The auto-encoder network encodes (trains) a set of first features in the Group A behavioral data 214 into a reduced dimensional space of a first machine learning network, such as a neural network 108a. The auto-encoder network is encoded (trained) to extract the features from the Group A behavioral data 214 that summarize the interactions or transactions by the first group of users with the resources. The extracted features, also referred to as embedded behavioral data 322, are then used as reference data indicative of other users whose intent is to conduct similar interactions or transactions with a corresponding resource.

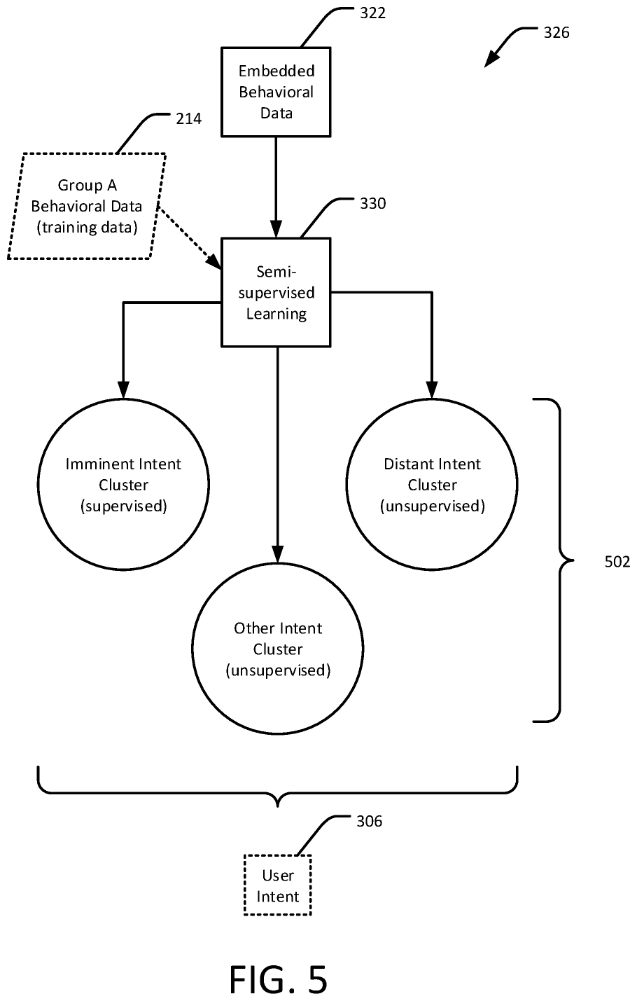

The Group B behavioral data 216 is applied to the encoded (trained) auto-encoder network, which extracts the features from the Group B behavioral data 216, which are then used as reference data indicative of the behavioral data for each of the users in the second group (e.g., Group B). The embedded behavioral data 322 is then fed into an intent pattern inference network 326, such as shown in FIG. 5, for clustering with the Group B behavioral data 216. In contrast to existing machine learning techniques that are trained on prior behavioral data of one type or group of users, the intent pattern inference network 326 includes a second machine learning network 330, which in some examples includes a semi-supervised learning network seeded with the embedded behavioral data (features) derived from the Group A behavioral data 214. The intent pattern inference network 326 extracts features from the Group B behavioral data 214 and clusters those features with similar features extracted from the Group A behavioral data 212 by the auto-encoder network. These clusters of similar features represent an intent 306 (e.g., imminent intent, distant intent, or other types of intent) by the second group of users to transact or interact with similar resources as the first group of resources imminently or in a relatively short amount of time (also referred to as imminent intent). Other identified clusters of features (e.g., features from the Group B behavioral data that are not similar or less similar to the features from the Group A behavioral data) are associated with one or more other types of user intent, such as window shopping, searching for something specific that might not be present, browsing for out-of-the-usual items, or other exploration-type intent where transactions or interactions between the user and the resource are not imminent (also referred to as distant intent).

The output of Intent Determination stage 302, and an input to the Intent-informed Recommendation stage 304, is a value representing the intent 306 of the user. The user intent 306, as noted above, is a value representing a range of possible intents, from an imminent intent to complete a transaction or interaction, to an unlikely or distant intent to complete the transaction or interaction. As discussed in further detail below, the Intent-informed Recommendation stage 304 generates one or more recommendations (e.g., an exploitation recommendation 222 or an exploration recommendation 224) based at least in part on the user intent 306 and other raw user interaction data 218 (e.g., interactions by a user in a current web session).

Auto-Encoder Neural Network for Identifying Repeatable Patterns

FIG. 4 shows the structure of an example unsupervised pattern extraction process 320 that is a component of the intent-informed recommendation application 116 of FIG. 1, in accordance with some embodiments of the present disclosure. Specifically, the unsupervised pattern extraction process 320 employs a neural network structure 108a to extract patterns, or features, of user behavior from the first group of users. As an illustration, the Group A behavioral data 214 is provided to the auto-encoder network. One or more filters are applied to the Group A behavioral data 214 by one or more convolutional layers 420, according to some embodiments. More specifically, the convolutional layers 420 break down the Group A behavioral data 214 into various filtered feature maps that identify features in the data. In some examples, the salient behavioral features are those associated with the interactions or transactions of the Group A users with one or more resources. For example, the interactions can include searching for, viewing of, and/or purchasing of one or more resources by one or more users in the first group of users.

According to some embodiments, pooling layers 430 are used to further down sample the detected features from the feature maps generated by the convolutional layers 420. In essence, pooling layers 430 operate on the individual feature maps to generate smaller pooled feature maps. The pooled feature maps summarize the feature data from the feature maps. Once the pooled feature maps have been generated from Group A behavioral data 214, the feature maps are fed as input to a neural network 108a.

The neural network 108a includes an input layer 418, one or more hidden layers 420, and an output layer 422. Each of the layers of neural network 108a include neurons (represented by circles in each layer) that represent mathematical functions and/or weights applied to data received as input to the neuron. The output of a neuron of one layer is received by each of the neurons in the proceeding layer. Accordingly, input layer 418 of neural network 108a can include any number of neurons that receive the behavioral feature data from the pooled feature maps generated by the pooling layer 430.

In more detail, the neural network 108a is a type of unsupervised neural network with n input units and n output units (i.e., the number of neurons in the input layer 418 is the same as the number of neurons in the output layer 422) and at least one hidden layer with m units, where m<n. The neural network 108a is trained with a backpropagation algorithm to reproduce the input layer 418 at the output layer 422. Such an auto-encoder neural network effectively reduces the numeric columns in the data by using the output of the hidden layers 420 to represent the input layer 418. The first part of the neural network 108a from the input layer 418 to the hidden layer of m units 420 is an encoder. The encoder compresses the n dimensions of the input dataset into an m-dimensional space, thus providing a reduced encoding of the input data. The second part of the neural network 108a from the hidden layer 420 to the output layer 422 is a decoder. The decoder expands the data layer from an m-dimensional space into the original n-dimensional dataset and brings the data back to their original values, thus reconstructing a representation as close as possible to the original input.

According to some embodiments, the hidden layers 420 are configured during training of neural network 108a to identify features of user behavior based on the features encapsulated in the pooled feature maps. The number of hidden layers 420, the number of neurons in each of the layers, and the function performed by each neuron are established during training as neural network 108a learns how to distinguish between different behaviors. Accordingly, the characteristics (e.g., number of layers, number of neurons in a given layer, etc.) of the hidden layers 420 can be different depending on various training factors. According to some embodiments, output layer 422 includes a number of neurons that correspond to the possible behavioral features in the Group A behavioral data 214. For example, at least one of the neurons in the output layer 422 corresponds to a specific interaction in the Group A behavioral data 214 with a specific resource (e.g., a purchase by the user of a certain product), thus reproducing the features of the input data at the output layer.

For example, and as noted above, the neural network 108a can be used to identify repeatable patterns (features) of behavior and their recurrence over time (patterns) in the Group A behavioral data 214. In other words, the neural network 108a is trained to reconstruct the input layer, which is the Group A behavioral data 214, as an output layer of extracted features 410, which represents the embedded (encoded) behavioral data 322. After training, the values of the hidden layer nodes 420 of the neural network 108a are configured to encode the behavioral features of the Group A behavioral data 214. These behavioral features encoded in the neural network 108a are also referred to as embeddings. The features (embeddings) are used for comparison against the Group B behavioral data 216. The neural network 108a, once trained, effectively ignores signal noise, or data that is not consistent with the learned patterns, when such data (e.g., the Group A behavioral data 214 and/or the Group B behavioral data 216) is input to the network. As a result, the output of the neural network 108a (e.g., the extracted features 510) is very close to a copy of the input (the Group A behavioral data 214).

In more detail, the neural network 108a includes a feature layer that encodes the Group A behavioral data 214. For example, each input node 418 of the neural network 108a can represent a product 202 in a product catalog and the value of that node, as encoded in the network, is the number of times that item was visited (e.g., he number of webpage views of that item) during a user session. Another set of nodes in the input layer 418 represent second order item information. For example, each of the second order item nodes can represent a pair of items visited sequentially (e.g., one after the other) in a user session. The values of one of the second order item nodes is the number of times the pair of items represented by that node were visited consecutively. It will be understood that the input layer 418 can include higher order magnitudes of the Group A behavioral data 214. For example, another set of nodes representing triplets of items visited consecutively may be added to the input layer. As an example, items X, Y, Z are visited one after the other without interruption by a visit to another item W. In other words, a visit to X, then Y, then Z; or Y, then X, then Z; or Z, then X then Y.

As noted above, the hidden layers 420 of the neural network 108a have a lower dimension than the input layer 418. The hidden layers 420 summarize the data in the input layer 418 by condensing it into a denser (i.e., less sparse) lower dimensional layer. In some examples, the input layer 418 can be a sparse vector and the hidden layers 420 thus summarize the information in the input layer into a denser, lower dimensional vector. The hidden layers 520 of the neural network 108a gradually decrease the size of the input layer 418 by, for example, a factor of 10. For instance, if the first input layer is 40,000 dimensional then the first hidden layer will be 4,000 dimensional, the second hidden layer will be 400 dimensional, and the third hidden layer will be 40 dimensional. Further subsequent layers then expand the network by increasing the sizes by, for example, a factor of 10. For example, the fourth, fifth, and sixth layers will be 400, 4,000, and 40,000 dimensional respectively, with the 40,000-dimensional layer being the output layer of the auto-encoder.

It will be appreciated that although an auto-encoder network can be implemented in the process 300 as described above, any number of different dimensionality reduction or pattern mining techniques can be implemented, including but not limited to: missing values ratio; low variance in column values; high correlation between column values; principal component analysis (PCA); candidates and split columns in a random forest; backward feature elimination; forward feature construction; linear discriminant analysis (LDA); t-distributed stochastic neighbor embedding (t-SNE); breadth-first search (BFS); and depth first search (DFS). More generally, any technique that reduces the dimensionality of a dataset can be used to identify repeatable patterns, or features, of behavior in the Group A behavioral data 214.

Semi-Supervised Clustering for Inferring User Intent

FIG. 5 is a block diagram of the intent pattern inference network 326 that is a component of the intent-informed recommendation application 116 of FIG. 1, in accordance with some embodiments of the present disclosure. The intent pattern inference network 326 is trained on historical behavioral data from the Group A behavioral data 214. As noted above, in contrast to existing techniques that use prior behavioral data from one type or group of users, here the Group A behavioral data 214 and the Group B behavioral data 216 are both passed through the trained neural network 108a (see FIG. 4) to obtain the corresponding values (the embedded behavioral data 322) of the respective hidden layers of the neural network 108a for the first and second groups of users (i.e., intent inference), respectively. The embedded behavioral data 322 correspond to users in the first and second groups that ended up making a purchase during a user session (imminent intent) and users in the first and second groups that did not make a purchase by the end of the user session (distant intent or other intent).

The first group of users are then clustered into one of the clusters 502 (e.g., the imminent intent cluster) according to the embedded behavioral data 322 via the second machine learning network 330. The centroid of each cluster 502 is then computed at the mean of the features of the first group of users. Subsequently, each user from the second group of users that performed an interaction that led to a conversion (e.g., completing a purchase) for a resource is also assigned to the same cluster as the first group of users (e.g., the imminent intent cluster) using a supervised clustering technique. The remaining users from the second group (i.e., those that did not end up completing a conversion) are then separately clustered in an unsupervised manner (using an unsupervised clustering technique) to determine other types of behaviors of the second group of users that are not associated with making a conversion during a user session. When a new user enters the second group (for example, by visiting a website), the data for that user is passed through the neural network 108a of FIG. 4 to determine the values of the features (i.e., the embedded behavioral data 322), and that user is then assigned to the closest cluster via the second machine learning network 330. Each of the clusters 502 represents the user intent 306 produced by the Intent Determination stage 302.

Intent-Informed Recommendations

Referring again to FIG. 3, and as discussed above, the output of Intent Determination stage 302, and the input to the Intent-informed Recommendation stage 304, is a value representing the intent 306 of the user. The intent 306 is a value representing a range of possible intents, from an imminent intent to complete a transaction or interaction, to an unlikely or distant intent to complete the transaction or interaction.

The Intent-informed Recommendation stage 304 includes a process for generating one or more recommendations, such as an exploitation recommendation 222 and/or an exploration recommendation 224, based on the intent 306 produced by the Intent Determination stage 302 and the additional raw user interaction data 218 obtained from a user's current interactions with a website or other resource. For example, the exploitation recommendation 222 and/or exploration recommendation 224 is modulated by the intent 306 such that an intent value representing imminent intent (e.g., a high likelihood that the user is about to make a purchase during the current user session) causes the exploitation recommendations 222 to be more heavily weighted than the exploration recommendations 224. By contrast, an intent value representing a distant intent (e.g., a low likelihood that the user is about to make a purchase during the user session) causes the exploration recommendations 224 to be more heavily weighted than the exploitation recommendations 222. Additionally, the intent 306 is used to inform other aspects related to the presentation of the recommendations. For example, the intent 306 can be used to determine the location (e.g., which website or which position on a webpage) and the time (when) the recommendation is presented to the user. In another example, the intent 306 can be used to determine whether to include a process for rapidly processing a transaction (e.g., fast checkout) or not (e.g., save item to a wish list) depending on the user intent as well as where the recommendation is presented (e.g., on a merchant's website, where the transaction can be processed directly, versus on a third-party website, where the transaction cannot be processed directly).

Further, in accordance with some embodiments, the Intent-informed Recommendation stage 304 can include a recommendation process that operates on all users equally regardless of the intent 306 uses global behavioral data (i.e., transactions or interactions for all users including users who are not members of Group A or Group B) to learn collaboratively which resources to recommend. For example, a collaborative filter can be derived from the intent 306 to leverage both collaborative and collective user data as well as personalized recommendations that are determined by the intent 306. In another example, a content-based filter can be used to pass or block certain recommended resources that match the intent.

In accordance with an embodiment of the present disclosure, an implementation informed by intent is as follows. Each of the clusters 502 (see FIG. 5) representing the user intent 306 serves as a separate training set for a collaborative-filter based recommendation system that employs exploration (i.e., the exploration/exploitation principle). For example, collaborative filtering is the process of filtering for information or patterns among multiple agents, viewpoints, and/or other data sources. Collaborative filtering can be applied to different types of data including, for example, financial data, such as financial service institutions that integrate many financial sources, or on user data in e-commerce and web applications. For example, a collaborative filter can select users who share similar behavioral patterns. Then each new data point (e.g., a user) that interacts with a website can be recommended items according to the recommendation algorithm trained on the cluster 502 the user is assigned to, or be recommended items according to a recommendation algorithm that combines the weights of the items recommended by each of the cluster-specific algorithms, where the weights are proportional to the inverse of the distance (of the user data point) to each of the clusters. In other words, the recommendations can combine the results of the cluster-specific recommendations, where the weights combining the cluster-specific recommendations are inversely proportional to the distance from a user data point to each of the clusters 502; that is, the closer the user is to a particular cluster, the more weight is applied to the recommendations of that cluster.

In some embodiments, the Intent-informed Recommendation stage 304 can target recommendations for an audience in relation to the intent value, where the audience, also referred to as an audience segment, represents at least one user who generated at least a portion of the raw user interaction data. For example, an audience segment can be defined as one or more users who have a certain intent, such as “70% likely to buy.” As discussed above, the intent is determined from the interactions and behaviors of the first group of users (e.g., the B2B users). In this manner, the recommendations can be targeted to a group (or sub-group) of users (e.g., the B2C users) by audience segment. Thus, the Intent-informed Recommendation stage 304 can cause the recommendation(s) to be presented to the audience (e.g., any or all of the users in the audience segment) in relation to the at least one resource (e.g., a good, service, information, or other product) via a graphical user interface (e.g., a webpage).

Example Methodology for Intent-Informed Recommendations

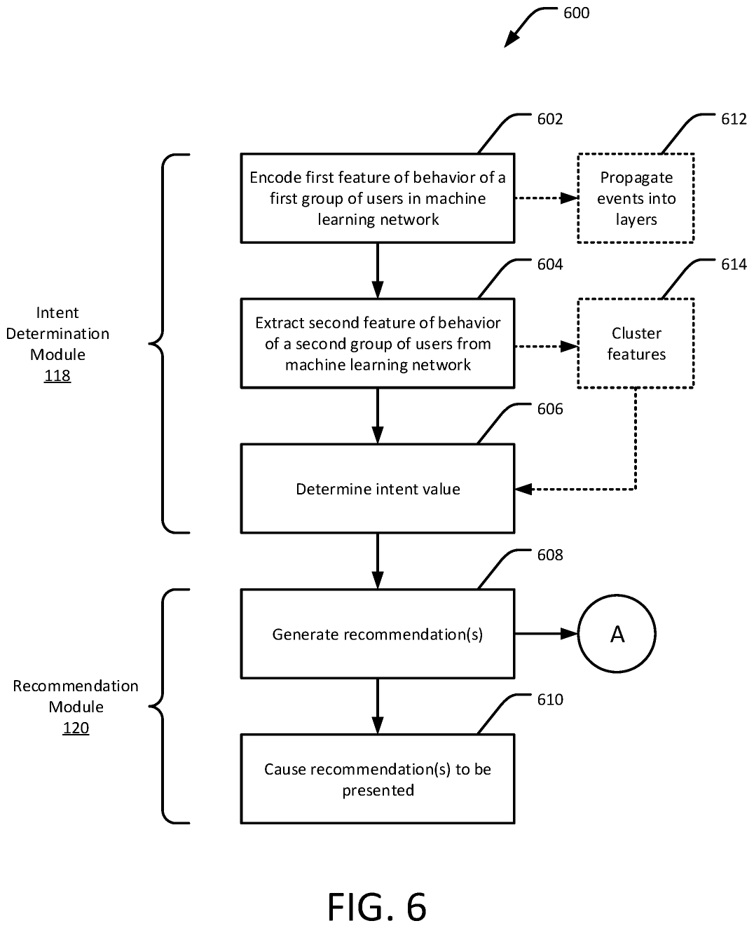

FIG. 6 is a block diagram of an example methodology 600 for generating intent-informed recommendations, in accordance with an embodiment of the present disclosure. The methodology 600 can, for example, be implemented in the system 100 of FIG. 1. The methodology 600 includes encoding 602, by an intent determination module, a first feature into a first machine learning network. The encoding can be achieved, for example, by propagating a first set of behavioral data through a plurality of layers in the first machine learning network, where the first feature represents one or more interactions (behavior) between at least one member of a first group of users and at least one resource (e.g., a good, service, information, or other product). The methodology 600 further includes extracting 604, by the intent determination module, a second feature from the first machine learning network by applying a second set of behavioral data to the first machine learning network, the second feature representing one or more interactions between at least one member of a second group of users and the at least one resource.

The methodology 600 further includes determining 606, by the intent determination module, an intent value. The intent value can be determined, for example, by clustering the first feature and the second feature into at least one cluster using a second machine learning network, where the intent value represents a number of times the first feature is encoded into a node of the first machine learning network, or another value indicative of the intent. The methodology 600 further includes generating 608, by a recommendation module, at least one recommendation of the at least one resource based on a set of raw user interaction data and the intent value. In some embodiments, the methodology 600 includes causing 610, by the recommendation module, the at least one recommendation to be presented in relation to the at least one resource via a graphical user interface.

In some embodiments, the methodology 600 further includes encoding 612 the first feature by propagating n events in the first set of behavioral data into at least one of the layers of the machine learning network with m neurons, where m<n, thereby reducing a dimensionality of the first set of behavioral data.

In some embodiments, the methodology 600 further includes clustering 614 the first feature and the second feature into an imminent intent cluster using a supervised clustering technique or into a distant intent cluster using an unsupervised clustering technique.

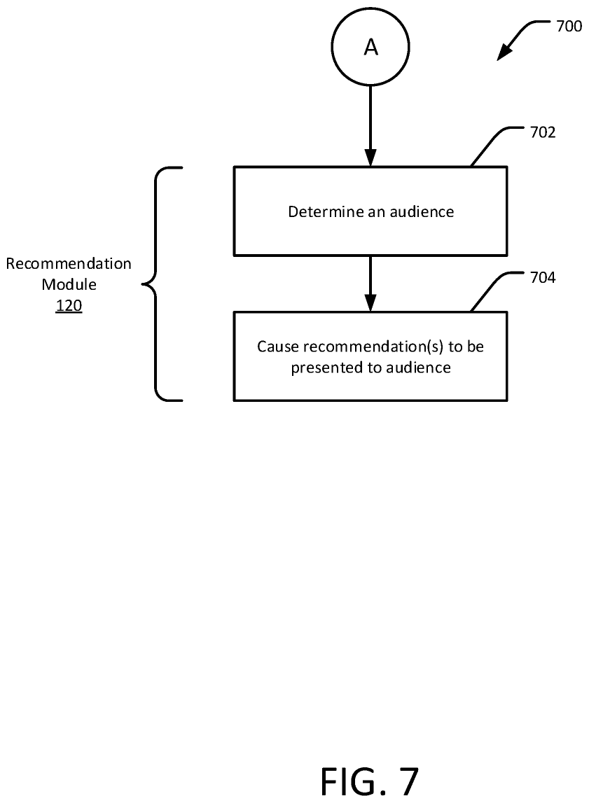

FIG. 7 is a block diagram of another example methodology 700 for generating intent-informed recommendations, in accordance with an embodiment of the present disclosure. The methodology 700 can, for example, be implemented in the system 100 of FIG. 1. The methodology 700 includes determining 702, by the recommendation module, an audience in relation to the intent value, the audience representing at least one user who generated at least a portion of the raw user interaction data, and causing 704, by the recommendation module, the at least one recommendation to be presented the audience in relation to the at least one resource via a graphical user interface.

Embodiments described herein variously provide several advantages over existing techniques, particularly in online shopping environments. For example, online merchants who operate both B2B and B2C storefronts are provided with the opportunity to leverage the more structured buying journey of the B2B users (i.e., behavior) to improve the experience of their B2C users. Notably, B2B behavior can be used to seed an unsupervised clustering technique for predicting intent on a B2C website. Because B2B behavior tends to be more predictable than B2C behavior, the imminent intent associated with most B2B behavior patterns can be correlated with any B2C behavior patterns that are similar to the more predictable, imminent intent driven B2B behavior. Thus, the disclosed techniques for generating intent-informed recommendations improve upon existing recommendation techniques by making the recommendations more relevant to the inferred intent of the user, which increases conversions (sales) in an e-commerce environment.

### FURTHER EXAMPLES

Example 1 provides a method for generating intent-informed product recommendations. The method includes encoding, by an intent determination module, a first feature into a first machine learning network by propagating a first set of behavioral data through a plurality of layers in the first machine learning network, the first feature representing one or more interactions between at least one member of a first group of users and at least one resource, the first group of users including business-to-business (B2B) shoppers and the at least one resource includes one or more products offered for sale via an online shopping platform; extracting, by the intent determination module, a second feature from the first machine learning network by applying a second set of behavioral data to the first machine learning network, the second feature representing one or more interactions between at least one member of a second group of users and the at least one resource, wherein the second group of users includes business-to-customer (B2C) shoppers; determining, by the intent determination module, an intent value by clustering the first feature and the second feature into at least one cluster using a second machine learning network, the intent value representing a number of times the first feature is encoded into a node of the first machine learning network; and generating, by a recommendation module, at least one product recommendation of the at least one resource based on a set of user interaction data and the intent value.

Example 2 includes the subject matter of Example 1, further including causing, by the recommendation module, the at least one product recommendation to be presented in relation to the at least one resource via a graphical user interface, wherein the intent value is used to determine (1) a location where the product recommendation is presented within the graphical user interface and/or (2) a time the product recommendation is presented.

Example 3 includes the subject matter of any of Examples 1-2, further including determining, by the recommendation module, an audience in relation to the intent value, the audience representing at least one user who generated at least a portion of the user interaction data; and causing, by the recommendation module, the at least one product recommendation to be presented the audience in relation to the at least one resource via a graphical user interface.

Example 4 includes the subject matter of any of Examples 1-3, where encoding the first feature further includes propagating n events in the first set of behavioral data into at least one of the layers of the machine learning network with m neurons, where m<n, thereby reducing a dimensionality of the first set of behavioral data.

Example 5 includes the subject matter of any of Examples 1-4, where generating the at least one product recommendation includes applying a collaborative filter weighted by the intent value to the user interaction data.

Example 6 includes the subject matter of any of Examples 1-5, where the first machine learning network includes an unsupervised auto-encoder neural network.

Example 7 includes the subject matter of any of Examples 1-6, where the second machine learning network includes a semi-supervised learning network seeded with the first feature, and where the clustering includes clustering the first feature and the second feature into an imminent intent cluster using a supervised clustering technique or into a distant intent cluster using an unsupervised clustering technique.

Example 8 includes the subject matter of any of Examples 1-7, where the one or more products offered for sale via the online shopping platform represents a good, a service, a source of information, or any combination thereof.

Example 9 provides a system for generating intent-informed recommendations. The system includes an intent determination module configured to encode a first feature into a first machine learning network by propagating a first set of behavioral data through a plurality of layers in the first machine learning network, the first feature representing one or more interactions between at least one member of a first group of users and at least one resource; extract a second feature from the first machine learning network by applying a second set of behavioral data to the first machine learning network, the second feature representing one or more interactions between at least one member of a second group of users and the at least one resource; and determine an intent value by clustering the first feature and the second feature into at least one cluster using a second machine learning network, the intent value representing a number of times the first feature is encoded into a node of the first machine learning network; and a recommendation module configured to generate at least one recommendation of the at least one resource based on a set of user interaction data and the intent value.

Example 10 includes the subject matter of Example 9, where the recommendation module is further configured to cause the at least one recommendation to be presented in relation to the at least one resource via a graphical user interface.

Example 11 includes the subject matter of any of Examples 9-10, where the recommendation module is further configured to: determine an audience in relation to the intent value, the audience representing at least one user who generated at least a portion of the user interaction data; and cause the at least one recommendation to be presented the audience in relation to the at least one resource via a graphical user interface.

Example 12 includes the subject matter of any of Examples 9-11, where encoding the first feature further includes propagating n events in the first set of behavioral data into at least one of the layers of the machine learning network with m neurons, where m<n, thereby reducing a dimensionality of the first set of behavioral data.

Example 13 includes the subject matter of any of Examples 9-12, where generating the at least one recommendation includes applying a collaborative filter weighted by the intent value to the user interaction data.

Example 14 includes the subject matter of any of Examples 9-13, where the first machine learning network includes an unsupervised auto-encoder neural network.

Example 15 includes the subject matter of any of Examples 9-14, where the second machine learning network includes a semi-supervised learning network seeded with the first feature, and wherein the clustering includes clustering the first feature and the second feature into an imminent intent cluster using a supervised clustering technique or into a distant intent cluster using an unsupervised clustering technique.

Example 16 provides a computer program product including one or more non-transitory machine-readable mediums having instructions encoded thereon that when executed by at least one processor cause a process to be carried out for generating intent-informed recommendations, the process including: encoding, by an intent determination module, a first feature into a first machine learning network by propagating a first set of behavioral data through a plurality of layers in the first machine learning network, the first feature representing one or more interactions between at least one member of a first group of users and at least one resource; extracting, by the intent determination module, a second feature from the first machine learning network by applying a second set of behavioral data to the first machine learning network, the second feature representing one or more interactions between at least one member of a second group of users and the at least one resource; determining, by the intent determination module, an intent value by clustering the first feature and the second feature into at least one cluster using a second machine learning network, the intent value representing a number of times the first feature is encoded into a node of the first machine learning network; and generating, by a recommendation module, at least one recommendation of the at least one resource based on a set of user interaction data and the intent value.

Example 17 includes the subject matter of Example 16, where the process further includes causing, by the recommendation module, the at least one recommendation to be presented in relation to the at least one resource via a graphical user interface.

Example 18 includes the subject matter of any of Examples 16-17, where the process further includes: determining, by the recommendation module, an audience in relation to the intent value, the audience representing at least one user who generated at least a portion of the user interaction data; and causing, by the recommendation module, the at least one recommendation to be presented the audience in relation to the at least one resource via a graphical user interface.

Example 19 includes the subject matter of any of Examples 16-18, where encoding the first feature further includes propagating n events in the first set of behavioral data into at least one of the layers of the machine learning network with m neurons, where m<n, thereby reducing a dimensionality of the first set of behavioral data.

Example 20 includes the subject matter of any of Examples 16-19, where generating the at least one recommendation includes applying a collaborative filter weighted by the intent value to the user interaction data, and wherein the first machine learning network includes an unsupervised auto-encoder neural network.

Example 21 provides a method for generating intent-informed recommendations, the method comprising: encoding, by an intent determination module, a first feature into a first machine learning network by propagating a first set of behavioral data through a plurality of layers in the first machine learning network; extracting, by the intent determination module, a second feature from the first machine learning network by applying a second set of behavioral data to the first machine learning network; determining, by the intent determination module, an intent value by clustering the first feature and the second feature into at least one cluster using a second machine learning network, the intent value representing a number of times the first feature is encoded into a node of the first machine learning network; and generating, by a recommendation module, at least one recommendation of the at least one resource based on a set of raw user interaction data and the intent value.

Example 22 includes the subject matter of Example 21, further comprising causing, by the recommendation module, the at least one recommendation to be presented in relation to the at least one resource via a graphical user interface.

Example 23 includes the subject matter of any of Examples 21-22, further comprising: determining, by the recommendation module, an audience in relation to the intent value, the audience representing at least one user who generated at least a portion of the raw user interaction data; and causing, by the recommendation module, the at least one recommendation to be presented the audience in relation to the at least one resource via a graphical user interface.

Example 24 includes the subject matter of any of Examples 21-23, wherein encoding the first feature further includes propagating n events in the first set of behavioral data into at least one of the layers of the machine learning network with m neurons, where m<n, thereby reducing a dimensionality of the first set of behavioral data.

Example 25 includes the subject matter of any of Examples 21-24, wherein generating the at least one recommendation includes applying a collaborative filter weighted by the intent value to the raw user interaction data.

Example 26 includes the subject matter of any of Examples 21-25, wherein the first machine learning network includes an unsupervised auto-encoder neural network.

Example 27 includes the subject matter of any of Examples 21-26, wherein the second machine learning network includes a semi-supervised learning network seeded with the first feature, and wherein the clustering includes clustering the first feature and the second feature into an imminent intent cluster using a supervised clustering technique or into a distant intent cluster using an unsupervised clustering technique.

Example 28 includes the subject matter of any of Examples 21-27, wherein the first feature represents one or more interactions between at least one member of a first group of users and at least one resource, and wherein the second feature represents one or more interactions between at least one member of a second group of users and the at least one resource.

Unless specifically stated otherwise, it may be appreciated that terms such as “processing,” “computing,” “calculating,” “determining,” or the like refer to the action and/or process of a computer or computing system, or similar electronic computing device, that manipulates and/or transforms data represented as physical quantities (for example, electronic) within the registers and/or memory units of the computer system into other data similarly represented as physical quantities within the registers, memory units, or other such information storage transmission or displays of the computer system. The embodiments are not limited in this context.

Numerous specific details have been set forth herein to provide a thorough understanding of the embodiments. It will be appreciated, however, that the embodiments may be practiced without these specific details. In other instances, well known operations, components and circuits have not been described in detail so as not to obscure the embodiments. It will be further appreciated that the specific structural and functional details disclosed herein may be representative and do not necessarily limit the scope of the embodiments. In addition, although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims.

1-9. (canceled)

11-20. (canceled)

21. A method for generating intent-informed recommendations, the method comprising:
encoding, by an intent determination module, a first feature into a first machine learning network by propagating a first set of behavioral data through a plurality of layers in the first machine learning network;
extracting, by the intent determination module, a second feature from the first machine learning network by applying a second set of behavioral data to the first machine learning network;
determining, by the intent determination module, an intent value by clustering the first feature and the second feature into at least one cluster using a second machine learning network, the intent value representing a number of times the first feature is encoded into a node of the first machine learning network; and
generating, by a recommendation module, at least one recommendation of the at least one resource based on a set of raw user interaction data and the intent value.

22. The method of claim 21, further comprising causing, by the recommendation module, the at least one recommendation to be presented in relation to the at least one resource via a graphical user interface.

23. The method of claim 21, further comprising:
determining, by the recommendation module, an audience in relation to the intent value, the audience representing at least one user who generated at least a portion of the raw user interaction data; and
causing, by the recommendation module, the at least one recommendation to be presented the audience in relation to the at least one resource via a graphical user interface.

24. The method of claim 21, wherein encoding the first feature further includes propagating n events in the first set of behavioral data into at least one of the layers of the machine learning network with m neurons, where m<n, thereby reducing a dimensionality of the first set of behavioral data.

25. The method of claim 21, wherein generating the at least one recommendation includes applying a collaborative filter weighted by the intent value to the raw user interaction data.

26. The method of claim 21, wherein the first machine learning network includes an unsupervised auto-encoder neural network.

27. The method of claim 21, wherein the second machine learning network includes a semi-supervised learning network seeded with the first feature, and wherein the clustering includes clustering the first feature and the second feature into an imminent intent cluster using a supervised clustering technique or into a distant intent cluster using an unsupervised clustering technique.

28. The method of claim 21, wherein the first feature represents one or more interactions between at least one member of a first group of users and at least one resource, and wherein the second feature represents one or more interactions between at least one member of a second group of users and the at least one resource.

29. A system for generating intent-informed recommendations, the system comprising:
an intent determination module configured to
encode a first feature into a first machine learning network by propagating a first set of behavioral data through a plurality of layers in the first machine learning network;
extract a second feature from the first machine learning network by applying a second set of behavioral data to the first machine learning network; and
determine an intent value by clustering the first feature and the second feature into at least one cluster using a second machine learning network, the intent value representing a number of times the first feature is encoded into a node of the first machine learning network; and
a recommendation module configured to generate at least one recommendation of the at least one resource based on a set of raw user interaction data and the intent value.

30. The system of claim 29, wherein the recommendation module is further configured to cause the at least one recommendation to be presented in relation to the at least one resource via a graphical user interface.

31. The system of claim 29, wherein the recommendation module is further configured to:
determine an audience in relation to the intent value, the audience representing at least one user who generated at least a portion of the raw user interaction data; and
cause the at least one recommendation to be presented the audience in relation to the at least one resource via a graphical user interface.

32. The system of claim 29, wherein encoding the first feature further includes propagating n events in the first set of behavioral data into at least one of the layers of the machine learning network with m neurons, where m<n, thereby reducing a dimensionality of the first set of behavioral data.

33. The system of claim 29, wherein generating the at least one recommendation includes applying a collaborative filter weighted by the intent value to the raw user interaction data.

34. The system of claim 29, wherein the first machine learning network includes an unsupervised auto-encoder neural network.

35. The system of claim 29, wherein the second machine learning network includes a semi-supervised learning network seeded with the first feature, and wherein the clustering includes clustering the first feature and the second feature into an imminent intent cluster using a supervised clustering technique or into a distant intent cluster using an unsupervised clustering technique.

36. A computer program product including one or more non-transitory machine-readable mediums having instructions encoded thereon that when executed by at least one processor cause a process to be carried out for generating intent-informed recommendations, the process comprising:
encoding, by an intent determination module, a first feature into a first machine learning network by propagating a first set of behavioral data through a plurality of layers in the first machine learning network, the first feature representing one or more interactions between at least one member of a first group of users and at least one resource;
extracting, by the intent determination module, a second feature from the first machine learning network by applying a second set of behavioral data to the first machine learning network, the second feature representing one or more interactions between at least one member of a second group of users and the at least one resource;
determining, by the intent determination module, an intent value by clustering the first feature and the second feature into at least one cluster using a second machine learning network, the intent value representing a number of times the first feature is encoded into a node of the first machine learning network; and
generating, by a recommendation module, at least one recommendation of the at least one resource based on a set of raw user interaction data and the intent value.

37. The computer program product of claim 36, wherein the process further comprises causing, by the recommendation module, the at least one recommendation to be presented in relation to the at least one resource via a graphical user interface.

38. The computer program product of claim 36, wherein the process further comprises:
determining, by the recommendation module, an audience in relation to the intent value, the audience representing at least one user who generated at least a portion of the raw user interaction data; and
causing, by the recommendation module, the at least one recommendation to be presented the audience in relation to the at least one resource via a graphical user interface.

39. The computer program product of claim 36, wherein encoding the first feature further includes propagating n events in the first set of behavioral data into at least one of the layers of the machine learning network with m neurons, where m<n, thereby reducing a dimensionality of the first set of behavioral data.

40. The computer program product of claim 36, wherein generating the at least one recommendation includes applying a collaborative filter weighted by the intent value to the user interaction data, and wherein the first machine learning network includes an unsupervised auto-encoder neural network.
